(19) United States
(12) Patent Application Publication
(10) Pub. No.: US 2024/0411914 A1
(43) Pub. Date: Dec. 12, 2024

(54) RANSOMWARE DETECTION AND PREVENTION

(71) Applicant: The Regents of the University of Michigan, Ann Arbor, MI (US)

(72) Inventors: Anys BACHA, Canton, MI (US); Abdul Rahman A.A. ABU ELKHAIL, Dearborn Heights, MI (US); Hafiz M.A. MALIK, West Bloomfield, MI (US)

(21) Appl. No.: 18/737,635

(22) Filed: Jun. 7, 2024

Related U.S. Application Data
(60) Provisional application No. 63/472,143, filed on Jun. 9, 2023.

(51) Int. Cl. G06F 21/62; G06F 21/55; G06F 21/56

(52) U.S. Cl. CPC G06F 21/6218; G06F 21/554; G06F 21/566

(57) ABSTRACT

A method for identifying ransomware in order to prevent unauthorized manipulation of a computer file and/or for preventing unauthorized manipulation of a computer file. The method includes: determining an entropy value in response to a write request issued by a running process; and in response to a determination that the entropy value exceeds a predetermined threshold, identifying the running process as ransomware and/or preventing data stored at a storage device from being manipulated by the running process. Aspects further include: in response to a determination that the entropy value exceeds a predetermined threshold and a determination that a socket request or a delete request was issued by the running process, preventing data stored at a storage device from being manipulated by the running process.

### GOVERNMENT SUPPORT CLAUSE

This invention was made with government support under 2035770 and 1947580 awarded by the National Science Foundation. The government has certain rights in the invention.

### TECHNICAL FIELD

The invention relates to ransomware detection and prevention and, more particularly, to detecting ransomware within a running file and preventing unauthorized manipulation of a computer file in response to the detection.

### BACKGROUND

Data encryption has proven to be an indispensable technology for preserving the confidentiality of today's digital content. Unfortunately, cybercriminals have discovered ways to re-purpose this technology and deny users access to their data in return for ransom, and such technology is generally referred to as ransomware. This trend has sparked an onslaught of ransomware attacks in recent years, resulting in users, businesses, and governments being extorted to pay ransoms in return for restoring their impacted data.

According to the U.S. Department of Homeland Security, ransomware represents the fastest growing malware threat to individuals and organizations. Some have predicted future ransomware attacks are slated to impact systems every two seconds. To this end, a wide range of business segments incurred significant damages as a result of ransomware, costing the pharmaceutical, shipping services, and chip manufacturing industries over hundreds of millions of dollars. Recently, the energy sector has fallen prey to such attacks after a major U.S. fuel pipeline was taken down, prompting the company to make an immediate ransom payment of millions of dollars in order to regain access to their encrypted data. Although the cost of ransomware attacks in 2021 has already been estimated to be $20 billion, future damages are projected to reach $265 billion over the next decade. This trend makes it imperative to explore solutions that can seamlessly recover from such attacks.

In response to these challenges, researchers have proposed several defenses that rely on the detection of such malware through monitoring file access, permission, API calls, registry key operations, and file type changes. Amin Kharraz, Sajjad Arshad, Collin Mulliner, William K. Robertson, Engin Kirda, UNVEIL: A Large-Scale, Automated Approach to Detecting Ransomware. USENIX Security Symposium 2016: 757-772; Scaife, N., Carter, H., Traynor, P., Butler, K.R., 2016a. CryptoLock (and Drop It): Stopping Ransomware Attacks on User Data. 2016 IEEE 36th International Conference on Distributed Computing Systems (ICDCS), 303-312; Jethva, B.; Traoré, I.; Ghaleb, A.; Ganame, K.; Ahmed, S. Multilayer ransomware detection using grouped registry key operations, file entropy and file signature monitoring. J. Comput. Secur. 2020, 28, 337-373; Jung, S.; Won, Y. Ransomware detection method based on context-aware entropy analysis. Soft Comput. 22, 6731-6740 (2018). Unfortunately, the response time of such solutions, from data collection to detection, often results in partially encrypted filesystems, leaving victims faced with ransom payment as the only viable option for recovery. To address the shortcomings of these solutions, the research community investigated solutions that can recover from ransomware. Andrea Continella et al., A Self-healing, Ransomware-aware Filesystem (Conference on Computer Security Applications) (2016); Jian Huang et al., Flashguard: Leveraging Intrinsic Flash Properties to Defend Against Encryption Ransomware (ACM SIGSAC Conference on Computer and Communications Security) (2017); Eugene Kolodenker et al., Defense Against Cryptographic Ransomware (ACM on Asia Conference on Computer and Communications Security) (2017). Such solutions include out-of-place writes to flash drives to retain transient plaintext data from writes to flash drives and collect cryptographic keys generated by OS and saving them to a key escrow to be used for recovery. Unfortunately, in addition to the limitation of such solutions to solid state drives, ransomware can overwrite such transient data and it can bypass these defenses by using its own crypto libraries. Furthermore, such solutions require manual user intervention and a long recovery period.

### SUMMARY

According to one aspect of the invention, there is provided a method of preventing unauthorized manipulation of a computer file. The method includes: determining an entropy value in response to a write request issued by a running process; and in response to a determination that the entropy value exceeds a predetermined threshold, preventing data stored at a storage device from being manipulated by the running process.

According to various embodiments, the method may further include any one of the following features or any technically-feasible combination of some or all of the features:
the entropy value is determined while data subject to the write request is cached in memory used by the processor for executing the running process;
the entropy value indicates entropy of the data that is represented as a measure of write coverage, and wherein the write coverage refers to an amount of data being written relative to subject data;
the subject data refers to a data block of a data file, and wherein the data block of the data file includes the data that is prevented from being manipulated;
monitoring for a write request;
when a write request entropy value for the write request exceeds a predetermined write request entropy threshold, updating a cumulative entropy value;
a write radix tree for the running process is created, and wherein the write radix tree indicates data files modified by the running process;
the entropy value is an average entropy value that is determined based on a cumulative entropy value taken over a predefined execution period;
the cumulative entropy value is updated when a write request entropy value exceeds a predetermined write request entropy threshold;
the write request entropy value is an entropy value for a present data block being processed by the running process;
the present data block is a portion of a data file that is being processed by the running process;
preventing data stored at a storage device from being manipulated by the running process includes preventing the data from being written by the running process to the storage device; and/or
the method is performed by at least one processor through executing computer instructions stored on the storage device or another storage device comprised of non-transitory, computer-readable memory.

According to another aspect of the disclosure, there is provided a method of preventing unauthorized manipulation of a computer file. The method includes: determining an entropy value in response to write requests issued by a running process; and in response to a determination that the entropy value exceeds a predetermined threshold and a determination that a socket request or a delete request was issued by the running process, preventing data stored at a storage device from being manipulated by the running process. According to various embodiments, the method may further include any one of the following features or any technically-feasible combination of some or all of the features listed above in connection with the method of the first aspect.

According to another aspect of the disclosure, there is provided a identifying ransomware in order to prevent unauthorized manipulation of a computer file. The method includes: determining an entropy value based on write requests issued by a running process; and in response to a determination that the entropy value exceeds a predetermined threshold and a determination that a socket request was issued by the running process, identifying the running process as ransomware. According to various embodiments, the method may further include any one of the following features or any technically-feasible combination of some or all of the features listed above in connection with the method of the first aspect.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram illustrating a communications system for a host computer configured to perform the method, according to one embodiment;

FIG. 2 is a block diagram illustrating a host computer runtime system for the host computer of FIG. 1 and comprising a system call interface, an operating system (OS) scheduler, and a page cache subsystem, according to one embodiment;

FIG. 3 is a flowchart illustrating a method of preventing unauthorized manipulation, according to one embodiment; and

FIG. 4 is a flowchart illustrating a method of preventing unauthorized manipulation, according to one embodiment.

### DETAILED DESCRIPTION

Herein is provided a system and method for preventing unauthorized manipulation of a computer file. The system and method may be used to prevent ransomware attacks carried out on a data file by a malicious party, such as where the malicious party seeks to encrypt the data file and to hold the cryptographic key ransom until a payment is received, such as by the owner or custodian of the data file. According to embodiments, the system and method include determining an entropy value based on write requests issued by a running process and identifying the running process as ransomware in response to a determination that the entropy value exceeds a predetermined threshold and a determination that a socket request and/or a delete request was issued by the running process. When the running process is identified as ransomware, a preventive action is taken, such as where data is prevented from being written by the running process to a storage device and/or a delete request is rejected and thereby not fulfilled.

The computer executing the running process is referred to as a “host computer.” The host computer is configured to execute one or more processes (each constitutes a “runtime process”) that, when a runtime process is executed, the runtime process is referred to as a “running process”; accordingly, “running process” refers to the runtime process that is being executed (run) by the processor, which herein is generally discussed in connection with monitoring for ransomware through performing processing based on operations issued by the runtime process.

According to embodiments, a novel runtime solution that autonomously defends against cryptographic ransomware is provided and implemented through the disclosed system and method. Unlike prior work that can leave victims with partially encrypted filesystems or costly downtimes that stem from long data recovery periods, the present runtime solution seamlessly preserves compromised data without having to undergo an explicit recovery process, at least according to embodiments. Based on the observation that maliciously encrypted data is initially buffered in the operating system's page cache before it is flushed to the underlying storage device, the runtime solution was developed for efficiently managing data synchronization between the memory and storage subsystems to prevent maliciously encrypted data from being permanently committed to the underlying storage. The robustness of this approach was evaluated against more than one thousand recently released samples that span 18 ransomware families. It was shown that this runtime solution reliably prevents manipulation of all files initiated by the samples that were tested. Furthermore, at least in embodiments, the runtime solution is resilient to ransomware that employ malicious techniques including master boot record infection and multi-threaded attacks. It was demonstrated that the below disclosed exemplary implementation incurs negligible overhead while running a diverse set of realistic workloads commonly used for measuring performance.

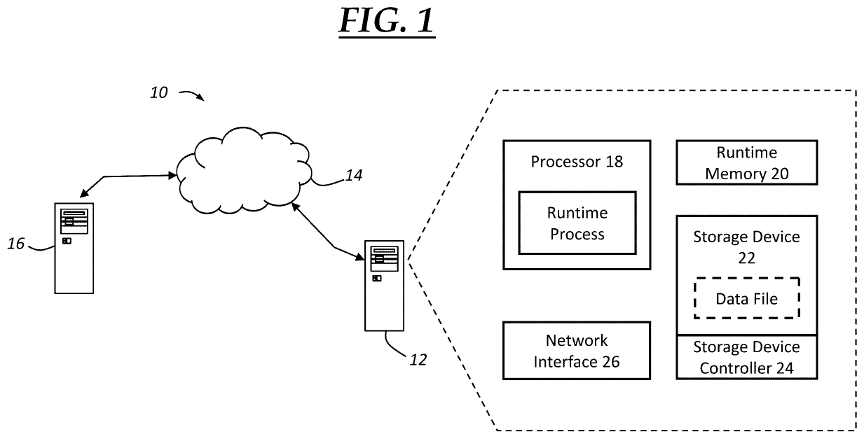

With reference to FIG. 1, there is shown a communication system 10 that includes a host computer 12, an interconnected data network 14, and a third party computer 16. The host computer 12 has a processor 18, runtime memory 20, a storage device 22, a storage device controller 24, and a network interface 26 used for communications with other computers, such as the third party computer 16, carried out over the interconnected data network 14. The interconnected data network 14 is used to carry out data communications between the host computer 12 and the third party computer 16, and may correspond to the Internet or other large, interconnected computer and/or carrier network.

In one scenario, the third party computer 16 is a backend server for a process that is executed by the host computer 12 and, more particularly, may be a ransomware server, such as a Command and Control (C&C) server that serves as a communication hub connecting the infected system's ransomware with the attacker. In certain scenarios, a ransomware attack may be carried out as follows: (1) ransomware spreads through methods like phishing emails, exploit kits, or malicious downloads and once a host's system is infected, the ransomware establishes a connection with the C&C server; (2) the C&C server enables the ransomware to receive instructions from the attacker, including ransom amount, payment details, decryption keys, and additional demands; and (3) upon payment or other agreement, the C&C server provides encryption keys to decrypt files, and keys may be manually released by the attacker or automatically retrieved by the ransomware.

The host computer 12 is shown as a desktop computer, but it will be appreciated that the system and method apply to a variety of computers, such as mobile computers (e.g., smartphones, tablets, laptops), among others. The host computer 12 is used to execute one or more processes, each of which is referred to as a “running process” when being executed (run) by the processor 18. The processor 18 may be any suitable electronic processor, such as: x86/x86-64 processors, such as Intel Core series (e.g., Intel™ Core i3, i5, i7, i9) and AMD Ryzen™ series (e.g., AMD Ryzen™ 3, 5, 7, 9), widely adopted in the personal computing domain; ARM processors, such as Qualcomm Snapdragon™ and Apple M1™ processors, which are popular for mobile and embedded systems; power architecture processors, like IBM Power9, which are oftentimes tailored for server and high-performance computing scenarios; SPARC™ (Oracle™) processors (e.g., SPARC M7, T7), which are oftentimes used for high-end servers; z/Architecture (IBM™) processors (e.g., IBM z15), oftentimes used in mainframe systems; MIPS processors (e.g., MIPS32, MIPS64), which are generally characterized by a reduced instruction set architecture, and are commonly used to address the requirements of embedded systems and networking devices; RISC-V processors (e.g., SiFive™, HiFive™), which is an open-source instruction set architecture, that is commonly used for research, embedded systems, and specialized computing environments; and other like electronic processors, such as graphics processing units (GPUs).

The runtime memory 20 refers to memory that is actively used during processing, and this runtime memory 20 corresponds to random access memory (RAM), typically used as main memory, in many applications. However, it will be appreciated that the runtime memory 20 may also refer to cache memory and/or virtual memory. Cache memory is a smaller and faster memory located closer to the central processing unit (CPU) (or main processor such as graphics processing unit (GPU)) and the cache memory serves as a buffer between the processor and main memory (RAM), and generally stores frequently accessed data and instructions. Virtual memory expands the effective size of the runtime memory beyond the physical RAM capacity and may utilize storage devices, such as the storage device 22. Virtual memory utilizes a combination of RAM and storage space (disk space) to simulate a larger memory capacity, thereby enabling running of larger programs and/or allowing multiple programs to be executed concurrently, generally by swapping data between RAM and disk as needed. Both cache memory and virtual memory are considered to constitute examples of “runtime memory” as that is used herein and this memory is implemented, at least in part, by volatile memory, such as RAM or cache memory.

The storage device 22 is a non-transitory, computer-readable memory that is implemented as non-volatile computer data storage devices, such as ROM (read-only memory), solid-state drives (SSDs) (including other solid-state storage such as solid-state hybrid drives (SSHDs)), other types of flash memory, hard disk drives (HDDs), magnetic or optical disc drives, non-volatile random access memory (NVRAM), etc. The storage device 22 is used to store data files that are to be accessed by the processor 18. The storage device controller 24 may be used to manage access and updates to the storage device 22. More particularly, the storage device controller 24 acts as an intermediary between the processor 18 and the storage device 22, through implementation of logic and protocols for data transfer, synchronization, and command processing. The storage device controller 24 may be used to manage data flow, interpret write requests, and coordinate storage operations.

The network interface 26 is used to enable the host computer 12 to communicate with other computers, such as the third party computer 16, via an interconnected data network, such as the interconnected data network 14. The network interface 26 is implemented, in embodiments, through a network interface card (or network adapter) and associated software or other programming. The network interface 26 is used to handle communication-related tasks, such as, for example, encapsulating data into network packets, carrying out network protocols, managing network addressing and routing, and facilitating data transfer between the host computer 12 and network infrastructure.

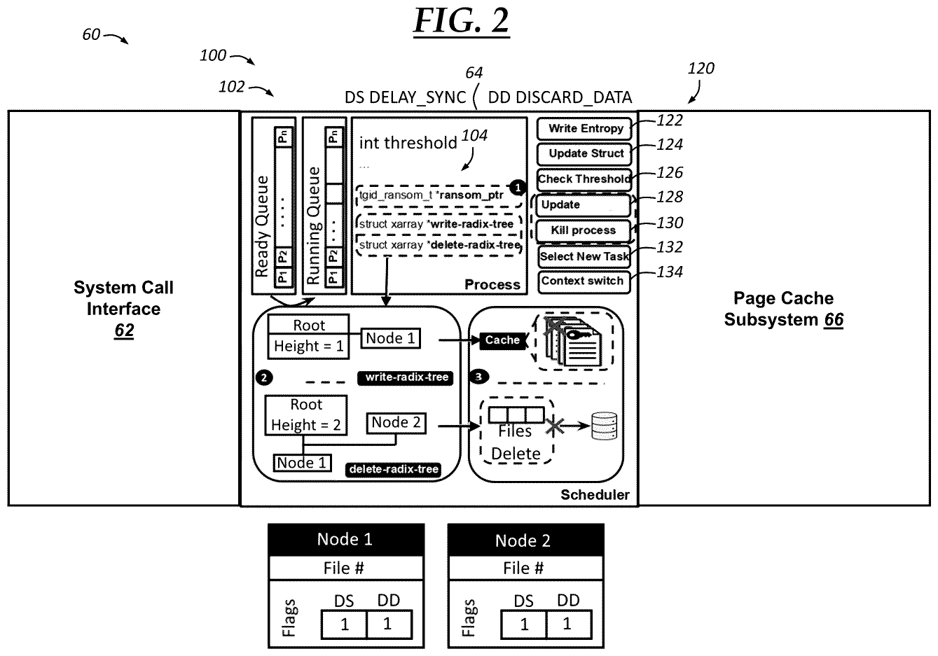

With reference to FIG. 2, there is shown a diagrammatic depiction of a host computer runtime system 60 having a system call interface 62, an operating system (OS) scheduler 64, and a page cache subsystem 66, each of which may be implemented through executing respective software therefor. The exemplary host computer runtime system 60 is implemented by a host computer, such as the host computer 12, for purposes of identifying ransomware and preventing it from maliciously encrypting or otherwise modifying data files on the host computer 12, at least in embodiments. The exemplary host computer runtime system 60 provides an end-to-end solution (this embodiment referred to as the “exemplary runtime solution” in the following discussion) that efficiently manages data synchronization between the runtime memory and storage subsystems to prevent maliciously encrypted data from being permanently committed to the underlying storage device (e.g., hard drive). To support this approach, the exemplary runtime solution was operated within the operating system through modifications to the system call interface, the OS scheduler, and the page cache subsystem; as discussed below, such modifications are embodied by the system call interface 62, the OS scheduler 64, and the page cache subsystem 66 of the present, exemplary embodiment.

FIG. 2 shows details of the OS scheduler 64 according to the present embodiment, which is shown as including data structures 104 used for ransomware detection, which include a ransomware detection data structure (tgid_ransom_t *ransom_ptr, described more below), a write radix tree (struct xarray *write-radix-tree), and a delete radix tree (struct xarray *delete-radix-tree). The OS scheduler 64 uses this data to determine whether to synchronize the storage device with the runtime memory so as to commit changes of a data file to the underlying storage. A modified runtime processing method 120 is shown as being performed by the OS scheduler 64. The method 120 includes: at 122, writing entropy in which an entropy value, such as a cumulative entropy value, is determined in response a write request; at 124, updating a ransomware detection data structure (e.g., tgid_ransom_t) based on the entropy value; and at 126, checking whether an entropy value (e.g., an average entropy value that is determined based on a cumulative entropy value taken over a predefined execution period) exceeds an entropy threshold; in embodiments, when the average entropy value exceeds the predetermined threshold, the running process is identified as ransomware; it will be appreciated that, in some embodiments, other conditions in addition to this threshold comparison may be used, such as whether there was a delete request or a socket request for the running process, as indicated by the socket_created and the delete_requested fields in the ransomware detection data structure. At 128, a sync tag is applied when it is determined that the entropy value exceeds the predetermined threshold; for example, in one embodiment, a delay sync tag (DELAY_SYNC, “DS” in FIG. 2) is set when the entropy value exceeds the predetermined threshold (e.g., “DS” set to “1” or “TRUE”); and, then, a discard data tag (DISCARD_DATA, “DD” in FIG. 2) is set after further evaluation, for example, such as when there was a delete request or a socket request for the running process. Then, at 130, because the running process is identified as ransomware (step 126/128), the running process is killed and terminated so that it is no longer being executed by the processor 18. Then, at 132, a new task is selected by the OS scheduler 64 and, at 134, the appropriate context for that new task is set.

The exemplary runtime solution is designed to track input/output (I/O) transactions that could result in the malicious modification of files (referred to as “data files”) present on the system and prevent the data files from reaching the backing store (i.e., the storage device). To this end, the system call interface 62 is augmented to monitor socket( ), write( ), and delete( ), operations issued from user space—these operations are referred to in the singular form as a socket request, a write request, and a delete request, respectively. In embodiments, all user space runtime processes are initially treated as benign until it is determined otherwise based on system call activity of the runtime process. In at least some embodiments, the exemplary runtime solution is used to monitor socket requests made by a running process, as this step may be quite useful because ransomware generally works by communicating with a C&C server in order to exchange the key that it will consume for encrypting the victim's data. Whenever a process issues a request to the kernel to create a network socket via the socket_create( ) system call, the exemplary runtime solution updates a data structure that is associated with the requesting runtime process (referred to as “tgid_ransom_t” in the present embodiment and “ransomware detection data structure” more generally). An example of this structure is shown below.

```
struct tgid_ransom_t {
  int periodic_cpu_time;
  int cumulative_entropy;
  int written_bytes;
  int socket_created;
  int delete_requested;
  int tcount;
};
```

More specifically, the ransomware detection data structure (tgid_ransom_t) of the requesting process is updated to reflect that a socket is being created using a socket create indicator (the socket_created field). Monitoring the socket_create( ) system call allows ransomware to be identified (flagged) that attempts to communicate with a C&C server over TCP (Transmission Control Protocol) and UDP (User Datagram Protocol), which are generally used for network communications.

In the present embodiment, the exemplary runtime solution is designed to monitor write requests made by a running process because all ransomware performs write operations for encrypting data files. Whenever a process issues a write request to the kernel via the write( ) system call, the exemplary runtime solution computes an entropy value representing the entropy of the data that is to be written as a first step. Further actions are then taken based on the outcome of this computation. In the event that the entropy value of the computed data exceeds a programmable threshold, the system proceeds to updating the ransomware detection data structure (tgid_ransom_t) associated with the requesting runtime process. At this point, the ransomware detection data structure (tgid_ransom_t) of the requesting process is updated to reflect the total number of bytes that have been written (“written byte amount”) using, for example, the written_bytes field of the tgid_ransom_t data structure. Similarly, the information corresponding to cumulative entropy value of the observed data using, for example, the cumulative_entropy field of the tgid_ransom_t data structure. The cumulative entropy (cumulative_entropy field) and written byte amount (written_bytes field) are consumed or used later by the OS scheduler 64 to compute the overall average entropy exhibited by the given runtime process over a predefined execution period. In addition to computing the entropy, the exemplary runtime solution also tracks the data files a given runtime process has modified through write transactions. This is accomplished through the use of a radix tree, and this type of data structure is chosen in the exemplary runtime solution because of its fast access time and ability to efficiently search data. A write radix tree (or write-radix-tree) is created for each running process, at least in embodiments. Moreover, according to embodiments, every time a runtime process initiates high entropy (over a predetermined threshold, such as the predetermined threshold above used for triggering adding to the cumulative entropy field) writes to a file, an entry that points to the corresponding file's data structure is added to the write radix tree and this will result in the DELAY_SYNC tag being set, which in the present embodiment acts as an indicator or marking not to sync write requests for the associated marked file—that is, this delay tag informs the I/O subsystem to delay synchronizing the marked file to the disk until further assessment is made about its corresponding process. In embodiments, the delay sync tag may be replaced with a prevent sync tag that prevents synchronizing the marked file to the disk without having to perform any further assessment.

The exemplary solution also enables the tracking of delete requests made by a running process. In certain situations, this step is quite useful because not all ransomware perform in-place writes for encrypting user files as some ransomware families create encrypted copies of the victim's files instead. Once such copies are produced, the ransomware proceeds to delete the original data (files in plaintext). As such, the exemplary runtime solution tracks runtime processes that perform delete operations: whenever a process issues a delete request to the kernel via the delete( ) system call, the exemplary runtime solution updates a delete requested indicator (delete_requested field) within the corresponding ransomware detection data structure (tgid_ransom_t) to reflect this behavior. The exemplary runtime solution aims to prevent deletion of files in the event that the corresponding runtime process is classified as ransomware. To achieve this, similar to the way the exemplary runtime solution handles write operations, when a delete request is made by the running process, an entry that points to the corresponding file's data structure is added to a delete radix tree (or delete-radix-tree). Furthermore, in embodiments, delete requests that are recorded in the delete radix tree are marked with the DELAY_SYNC tag. This informs the system to not permanently delete the data file from the backing store until further analysis is made. In embodiments, the delay sync tag may be replaced with a prevent sync tag that prevents deleting the marked file to the disk without having to first perform any further assessment.

In the exemplary embodiment, the OS scheduler 64 is configured to periodically evaluate runtime processes on the system and classifying such processes as one of benign, suspicious, or malicious, for example. To this end, the OS scheduler 64 relies on multiple features for classifying workloads, and such features may include network requests, delete operations, and entropy measurements that are tracked by the system call interface. The OS scheduler 64 carries out a few tasks upon every context switch, and this includes logging the amount of elapsed CPU time a given process was allocated on the system (using the periodic_cpu_time field), for example. The OS scheduler 64 uses this periodic_cpu_time to determine how often a process must be evaluated for its maliciousness. Once a runtime process has executed for a predetermined period (e.g., one (1) second), the OS scheduler 64 references the cumulative entropy value (cumulative_entropy) and written byte amount (written_bytes) that were previously saved by the system call interface 62 and computes the average entropy of the write transactions the runtime process has exhibited, and this is referred to as the “average entropy value”. When the computed average entropy value exceeds a predefined threshold, the process is considered to be suspicious (potentially malicious) and, thus, as an additional step, the OS scheduler 64 checks the runtime process's socket create indicator (socket_created) and delete request indicator (delete_requested). When any of the aforementioned flags are set, in addition to the average entropy value exceeding a predefined threshold, the runtime process is no longer considered to be suspicious, and is classified as malicious instead. Otherwise, the execution period (periodic_cpu_time), the cumulative entropy (cumulative_entropy), and the total number of written bytes (written_bytes) associated with the runtime process are reset in preparation for a new evaluation cycle. The socket create indicator (socket_created) and delete request indicator (delete_requested), on the other hand, are considered to be sticky—in other words, once set, they are not cleared throughout the lifetime of the runtime process.

Once a runtime process is classified as malicious, the OS scheduler 64 updates the tags of all previously marked files that are present in the process's radix trees (write and delete) to include a DISCARD_DATA tag. The DISCARD_DATA tag informs the I/O subsystem to discard data and it prompts the page cache to discard any memory pages that correspond to the malicious process. This tag also informs the I/O subsystem to permanently discard any file deletion requests. The OS scheduler 64 may conclude by sending an alert to a user of the host computer 12 (e.g., via a human-user interface such as a speaker or electronic display) and consequently terminates the corresponding runtime process. On the other hand, for a runtime process that is classified as benign, the runtime process's write radix tree is deleted to inform the page cache subsystem 66 that previously buffered write operations are now permitted to be synchronized to the storage device. And, in the exemplary runtime solution, all of the previously buffered delete requests are processed by permanently removing all of the files that have been tagged within the delete-radix-tree and, then, the delete radix tree is destroyed.

The page cache subsystem 66 is responsible for preventing malicious data from reaching the backing store so as to effect manipulation of the data files as they exist in the storage device 22. As a result, before this subsystem 66 designates any of its pages for synchronization or eviction from its cache, it first determines whether the associated file has been tagged, such as with a DELAY_SYNC and/or a DISCARD_DATA tag. This prompts the system to look up the file and owning process of each memory page that is under consideration for commitment to the storage device 22. More specifically, in the present embodiment, a (file, process) tuple is used to determine whether the data file exists within the corresponding radix tree. When it is determined that the data file is found within the process' radix tree, then the associated tags are examined. On the other hand, when it is determined that the data file does not exist, the respective pages are allowed to be committed.

In most cases, files that are written by user applications will not be recorded in the write-radix-tree since the entropy of such data is typically low. Under such circumstances, the ransom_ptr within the process's tgid_ransom_t would simply point to NULL implying that no radix tree exists. On the other hand, a file that exists within the radix tree and has the DELAY_SYNC tag set, as a result of write or delete operations, would result in the associated page to remain in the page cache until the scheduler classifies the associated process and updates the corresponding radix tree. In the event that the scheduler declares a process as malicious, the DISCARD_DATA tag would be set. This in turn results in the associated page being freed and its entry removed from the cache without being committed to the backing store. In other words, the underlying file will retain its original content on the backing store and ignore any write or delete transactions initiated by ransomware (i.e., manipulation of the data file is prevented). Therefore, the next time the data file is opened by the user, the original data will be seamlessly mapped into memory without any impact.

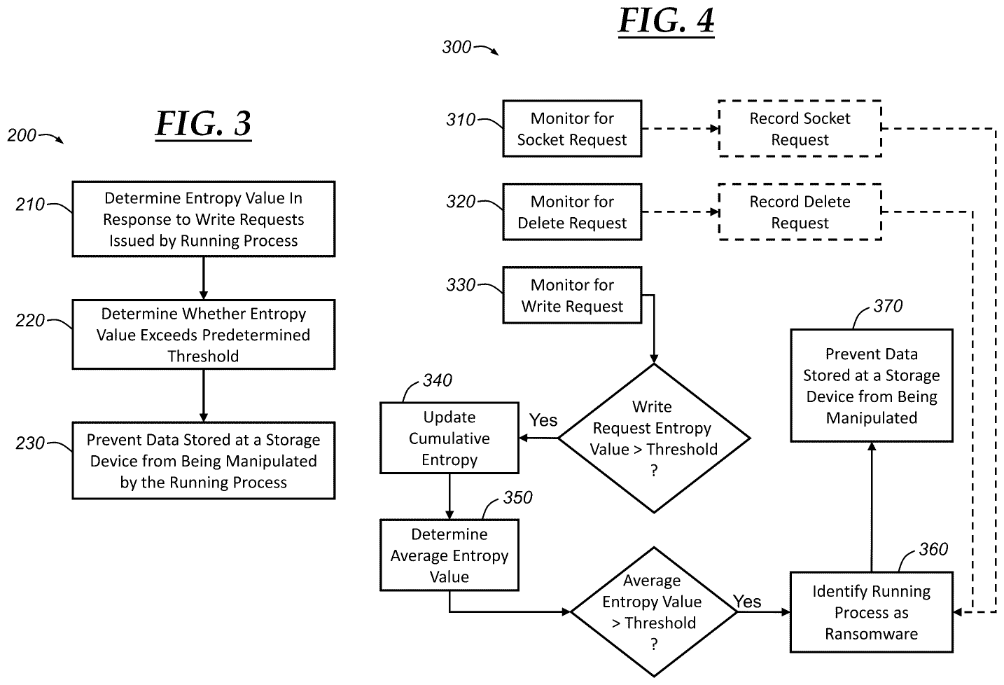

With reference to FIGS. 3-4, there are shown flowcharts illustrating an embodiment of a method 200 of preventing unauthorized manipulation (e.g., malicious encryption, unauthorized deletion) of a computer file (FIG. 3) and a method 300 of method of preventing unauthorized manipulation of a computer file (FIG. 4). The method 200 and the method 300 are each carried out by the host computer 12, at least according to one embodiment, and it will be appreciated that the method 300 may be used as a more specific implementation of the method 200, at least according to embodiments.

The method 200 is used to carry out a preventive or remedial action in response to identifying or determining that certain conditions associated with ransomware have been met for a given running process—i.e., the given running process is identified ransomware, meaning the host computer 12 is configured to treat it as such, which may include preventing unauthorized manipulation of a computer file.

The method 200 begins with step 210, wherein an entropy value is determined in response to write requests issued by a running process. The “running process” in this discussion refers to a runtime process that is being executed by the host computer and that is being monitored through use of the present method. In one embodiment, the entropy value is an average entropy value that is determined based on a cumulative entropy value taken over a predefined execution period. For example, as discussed above, the cumulative entropy value of the ransomware detection data structure is updated when a present entropy value is over a write request entropy threshold. The method 200 continues to step 220.

In step 220, it is determined whether the entropy value exceeds a predetermined threshold. The entropy value determined in step 210 is compared to the predetermined threshold and, when it is determined that the entropy value exceeds the predetermined threshold, the method 200 continues to step 230.

In step 230, data stored at a storage device is prevented from being manipulated by the running process. The data stored at the storage device is data that corresponds to the data in the runtime memory 20 that is manipulated by the processor 18. It will be appreciated that this data stored at the storage device is any data that is storable at an electronic storage device, such as word processing documents, other documents, software, etc. This data is prevented from being synchronized to the runtime memory thereby preventing manipulation of the underlying data as stored on the storage device 22. In embodiments, this step is performed by informing the page cache subsystem 66 which data files to discard so that manipulation to those data files, as effected by the running process, is prevented. As used herein, “manipulation” refers to the skillful or controlled handling, control, deletion or other alteration of data, and is often with the intent to achieve a desired outcome and, in some instances, a malicious outcome. In embodiments, preventing manipulation includes preventing files from being deleted as well as preventing files from being altered. The method 200 ends.

With reference now to FIG. 4, the method 300 begins with steps 310, 320, and 330, wherein a socket request, a delete request, and a write request are each monitored for, respectively. The running process issues requests to the operating system in order to request performance of certain operations, such as opening of a network socket, writing data to a storage device, or deleting a file stored at a storage device. In step 310, a socket request is monitored for. In embodiments, when a socket request is issued, an indicator in the ransomware detection data structure is provided, for example, which may be a flag or other indication that the running process issued a socket request. In some embodiments, the number of socket requests and/or other information about the socket request(s) is noted or recorded. In step 320, a delete request is monitored for. In embodiments, when a delete request is issued, an indicator in the ransomware detection data structure is provided, for example, which may be a flag or other indication that the running process issued a delete request. In some embodiments, the number of delete requests and/or other information about the delete request(s) is noted or recorded. In step 330, a write request is monitored for. In embodiments, when a write request is issued, a cumulative entropy value of the ransomware detection data structure is updated, for example. In some embodiments, the number of write requests and/or other information about the write request(s) is noted or recorded. The monitoring of steps 310, 320, and 330 may be performed simultaneously and recording of such issued requests may be performed in any suitable order. The method 300 continues to step 340.

In step 340, a cumulative entropy value is updated when a write request entropy value for the write request exceeds a predetermined write request entropy threshold. The predetermined write request entropy threshold may be stored in the storage device 22 or other storage and then referred to by the method 300 for comparison with the write request entropy value. The write request entropy value is an entropy value for a present data block being processed by the running process. The present data block is a portion of a data file that is being processed by the running process. The data file is a computer file that is stored on a storage device. When the running process issues the write request, the write request entropy value is determined and compared to the write request entropy threshold and, when the write request entropy value exceeds the write request entropy threshold, the cumulative entropy value is updated based on the write request entropy value. The method 300 continues to step 350.

In step 350, an average entropy value is determined based on the cumulative entropy value. The average entropy value indicates entropy of the data that is represented as a measure of write coverage taken over a predefined amount of time (or “predefined execution period”), and the write coverage refers to an amount of data being written relative to subject data. The entropy value is determined while data subject to the write request is cached in memory used by the processor for executing the running process.

In response to a determination that the average entropy value exceeds a predetermined threshold, the method 300 continues to step 360. The predetermined threshold (or predetermined average entropy threshold) may be stored in the storage device 22 or other storage and then referred to by the method 300 for comparison with the average entropy value.

In step 360, the running process is identified as ransomware when the average entropy value exceeds the predetermined threshold. In embodiments, a user may be notified that the running process is or is likely ransomware, and this may be provided to the user via the host computer 12, such as through one or more human-machine interfaces (HMIs) of the host computer 12 (e.g., audio speaker, electronic display). In other embodiments, another process of the host computer 12 is notified of this identification and/or another computer, such as a remote computer located remotely from the host computer 12, is notified of this identification.

In some embodiments, the running process is identified as ransomware when both conditions are met: the entropy value exceeds the predetermined threshold (as determined as a predicate of step 360) and a delete request or socket request was issued. For example, when a socket request is issued and the entropy value exceeds the predetermined threshold, then the running process is identified as ransomware. As another example, when a delete request is issued and the entropy value exceeds the predetermined threshold, then the running process is identified as ransomware. In some embodiments, additional criteria may be used as well, such as a socket request to a non-trusted domain or endpoint, for example. The method 300 continues to step 370.

In step 370, data stored at a storage device is prevented from being manipulated by the running process. This step is analogous to the step 230 of the method 200 and that discussion of the step 230 is hereby incorporated and attributed to the step 370. The method 300 ends.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of preventing unauthorized manipulation of a computer file, comprising the steps of:
determining an entropy value in response to a write request issued by a running process; and
in response to a determination that the entropy value exceeds a predetermined threshold, preventing data stored at a storage device from being manipulated by the running process.

2. The method of claim 1, wherein the entropy value is determined while data subject to the write request is cached in memory used by the processor for executing the running process.

3. The method of claim 1, wherein the entropy value indicates entropy of the data that is represented as a measure of write coverage, and wherein the write coverage refers to an amount of data being written relative to subject data.

4. The method of claim 3, wherein the subject data refers to a data block of a data file, and wherein the data block of the data file includes the data that is prevented from being manipulated.

5. The method of claim 1, further comprising:
monitoring for a write request; and
when a write request entropy value for the write request exceeds a predetermined write request entropy threshold, updating a cumulative entropy value.

6. The method of claim 1, wherein a write radix tree for the running process is created, and wherein the write radix tree indicates data files modified by the running process.

7. The method of claim 1, wherein the entropy value is an average entropy value that is determined based on a cumulative entropy value taken over a predefined execution period.

8. The method of claim 7, wherein the cumulative entropy value is updated when a write request entropy value exceeds a predetermined write request entropy threshold, and wherein the write request entropy value is an entropy value for a present data block being processed by the running process.

9. The method of claim 8, wherein the present data block is a portion of a data file that is being processed by the running process.

10. The method of claim 1, wherein preventing data stored at a storage device from being manipulated by the running process includes preventing the data from being written by the running process to the storage device.

11. The method of claim 1, wherein the method is performed by at least one processor through executing computer instructions stored on the storage device or another storage device comprised of non-transitory, computer-readable memory.

12. A method of preventing unauthorized manipulation of a computer file, comprising the steps of:
determining an entropy value in response to write requests issued by a running process; and
in response to a determination that the entropy value exceeds a predetermined threshold and a determination that a socket request or a delete request was issued by the running process, preventing data stored at a storage device from being manipulated by the running process.

13. The method of claim 12, further comprising a step of preventing data stored at a storage device from being manipulated by the running process when the running process is identified as ransomware.

14. The method of claim 13, wherein preventing data stored at a storage device from being manipulated by the running process includes preventing the data from being written by the running process to the storage device.

15. The method of claim 12, wherein the entropy value is determined while data subject to the write request is cached in memory used by the processor for executing the running process.

16. The method of claim 12, wherein the entropy value indicates entropy of the data that is represented as a measure of write coverage, and wherein the write coverage refers to an amount of data being written relative to subject data.

17. The method of claim 16, wherein the subject data refers to a data block of a data file, and wherein the data block of the data file includes the data that is prevented from being manipulated.

18. The method of claim 12, wherein a write radix tree for the running process is created, and wherein the write radix tree indicates data files modified by the running process.

19. The method of claim 12, wherein the entropy value is an average entropy value that is determined based on a cumulative entropy value taken over a predefined execution period.

20. A method of identifying ransomware in order to prevent unauthorized manipulation of a computer file, comprising the steps of:
determining an entropy value based on write requests issued by a running process; and
in response to a determination that the entropy value exceeds a predetermined threshold and a determination that a socket request was issued by the running process, identifying the running process as ransomware.
